(19) United States
(12) Patent Application Publication
(10) Pub. No.: US 2024/0326574 A1
(43) Pub. Date: Oct. 3, 2024

(54) KINETIC ENERGY RECOVERY SYSTEM

(71) Applicant: VOLVO TRUCK CORPORATION, Göteborg (SE)

(72) Inventors: Philemon CHAVRIER, Lyon (FR); Olivier POUSSIN, Lyon (FR); Cedric MAZAUFROY, Miribel (FR); Sebastien PESENTI, St Priest (FR)

(73) Assignee: VOLVO TRUCK CORPORATION, Göteborg (SE)

(21) Appl. No.: 18/606,563

(22) Filed: Mar. 15, 2024

(30) Foreign Application Priority Data
Mar. 29, 2023 (EP) 23165144.9

(51) Int. Cl. B60K 6/10; B60K 6/26; B60K 6/28; B60K 6/30

(52) U.S. Cl. CPC B60K 6/105; B60K 6/26; B60K 6/28; B60K 6/30

(57) ABSTRACT

An energy recovery system for a vehicle is presented. The energy recovery system comprises a Kinetic Energy Recovery System, KERS, for connecting to a propulsion shaft of the vehicle, an internal energy storage device configured to receive and store energy from the KERS, and a processing circuitry configured to cause distribution of energy from the internal energy storage device to the propulsion shaft of the vehicle and/or at least one non-propulsion battery for the vehicle based on an energy level of the non-propulsion battery.

### TECHNICAL FIELD

The disclosure relates generally to an energy recovery system. In particular aspects, the disclosure relates to a kinetic energy recovery system for a vehicle. The disclosure can be applied to heavy-duty vehicles, such as trucks, buses, and construction equipment, among other vehicle types. Although the disclosure may be described with respect to a particular vehicle, the disclosure is not restricted to any particular vehicle.

### BACKGROUND

The development of modern vehicles is fast, and energy efficiency, safety and comfort are just a few areas where continuous improvements are made.

With increasing awareness of the impact of fossil fuels on the environment, modern vehicles are under pressure to reduce emissions and become more fuel-efficient. This has led to the development of electric and hybrid vehicles, as well as more efficient combustion engines. While modern vehicles are generally safer than older models, there are still challenges in ensuring that they are as safe as possible. This includes improving crash test performance, developing better driver assistance technologies, and reducing the risk of accidents caused by distracted driving. Modern vehicles are much more complex than older models, with more advanced electronic systems, sensors, and computer control units. This complexity increases a demand on power sources and power reliability of the vehicle. Modern vehicles are often more expensive than older models, due to the increased complexity and advanced technology involved. This may make it difficult for some people to afford a new vehicle, and may also lead to higher repair costs for those who do purchase a new vehicle.

Based on the above, there is a need for improvements.

### SUMMARY

According to a first aspect of the disclosure, an energy recovery system for a vehicle is presented. The energy recovery system comprises a Kinetic Energy Recovery System, KERS, for connecting to a propulsion shaft of the vehicle, an internal energy storage device configured to receive and store energy from the KERS, and a processing circuitry configured to cause distribution of energy from the internal energy storage device to the propulsion shaft of the vehicle and/or at least one non-propulsion battery for the vehicle based on an energy level of the non-propulsion battery. The first aspect of the disclosure may seek to provide a system that enables an alternative to charging a non-propulsion battery with a generator or alternator. A technical benefit may include reducing cost, weight and maintenance of the vehicle.

In some examples, including in at least one preferred example, optionally, the processing circuitry is further configured to cause distribution of energy from the internal energy storage device based on an acceleration indicator obtained from the vehicle.

In some examples, including in at least one preferred example, optionally, the processing circuitry is configured to prevent distribution of energy from the internal energy storage device to the propulsion shaft of the vehicle responsive to the acceleration indicator indicating a negative acceleration of the vehicle.

In some examples, including in at least one preferred example, optionally, the internal energy storage device is a super capacitor.

In some examples, including in at least one preferred example, optionally, the processing circuitry is further configured to cause distribution of energy from the internal energy storage device to the non-propulsion battery and to prevent distribution of energy from the internal energy storage device to the propulsion shaft of the vehicle responsive to the energy level of the non-propulsion battery being below a first threshold.

In some examples, including in at least one preferred example, optionally, the processing circuitry is further configured to cause distribution of energy from the internal energy storage device to the propulsion shaft of the vehicle responsive to the energy level of the non-propulsion battery being above the first threshold.

In some examples, including in at least one preferred example, optionally, the processing circuitry is further configured to cause distribution of energy from the internal energy storage device to the propulsion shaft of the vehicle and to prevent distribution of energy from the internal energy storage device to the non-propulsion battery responsive to the energy level of the non-propulsion battery being above a second threshold, wherein the second threshold is indicating a higher energy level than the first threshold.

In some examples, including in at least one preferred example, optionally, preferably the processing circuitry is further configured to cause distribution of energy from the internal energy storage device to the non-propulsion battery and to the propulsion shaft of the vehicle responsive to the energy level of the non-propulsion battery being between the first and second thresholds.

In some examples, including in at least one preferred example, optionally, the processing circuitry is further configured to provide a recuperation indication to the vehicle indicating that the vehicle is to operate at an enforced energy recuperation mode.

In some examples, including in at least one preferred example, optionally, the processing circuitry is configured to provide the recuperation indication to the vehicle responsive to the energy level of the non-propulsion battery being below a minimum threshold, wherein the minimum threshold is below the first threshold.

In some examples, including in at least one preferred example, optionally, the energy recovery system further comprises the at least one non-propulsion battery.

In some examples, including in at least one preferred example, optionally, the energy recovery system further comprises at least two non-propulsion batteries.

In some examples, including in at least one preferred example, optionally, a first non-propulsion battery is configured for providing power to vehicle propulsion support functions and a second non-propulsion battery is configured for providing power to vehicle comfort control.

In some examples, including in at least one preferred example, optionally, at least one non-propulsion battery is a battery configured with a nominal voltage below 30 V.

In some examples, including in at least one preferred example, optionally, the KERS comprises an electrical motor.

In some examples, including in at least one preferred example, optionally, the KERS comprises a flywheel arrangement.

In some examples, including at least one preferred example, optionally, the processing circuitry is further configured to cause distribution of energy based on an acceleration indicator obtained from the vehicle and to prevent distribution of energy to the propulsion shaft of the vehicle responsive to the acceleration indicator indicating negative acceleration of the vehicle; the internal energy storage device is a super capacitor; the processing circuitry is further configured to cause distribution of energy of the internal energy storage device to the non-propulsion battery and to prevent distribution of energy of the internal energy storage device to the propulsion shaft of the vehicle responsive to the energy level of the non-propulsion battery being below a first threshold, and to cause distribution of energy of the internal energy storage device to the propulsion shaft of the vehicle responsive to the energy level of the non-propulsion battery being above the first threshold; the processing circuitry is further configured to cause distribution of energy of the internal energy storage device to the propulsion shaft of the vehicle and to prevent distribution of energy of the internal energy storage device to the non-propulsion battery of the vehicle responsive to the energy level of the non-propulsion battery being above a second threshold, wherein the second threshold indicating a higher energy level than the first threshold, and to cause distribution of energy of the internal energy storage device to the non-propulsion battery and to the propulsion shaft of the vehicle responsive to the energy level of the non-propulsion battery being between the first and second thresholds; the processing circuitry is further configured to provide a recuperation indication to the vehicle indicating that the vehicle is to operate at an enforced energy recuperation mode, and to provide the recuperation indication to the vehicle responsive to the energy level of the non-propulsion battery being below a minimum threshold, wherein the minimum threshold is below the first threshold; the energy recovery system further comprising at least two non-propulsion battery, wherein a first non-propulsion battery is configured for providing power to vehicle propulsion control and a second non-propulsion battery is configured for providing power to vehicle comfort control, at least one non-propulsion battery is a battery configured with a nominal voltage below 30 V; the KERS comprises an electrical motor and a flywheel arrangement.

According to a second aspect, a vehicle is presented. The vehicle comprises a non-propulsion battery for providing power to the vehicle, a propulsion shaft, a propulsion source coupled to the propulsion shaft, and an energy recovery system of the first aspect connected to the propulsion shaft.

In some examples, including in at least one preferred example, optionally, the propulsion source is selectively connected to the propulsion shaft.

In some examples, including in at least one preferred example, optionally, a controllable disconnect is provided between the propulsion source and the propulsion shaft. The KERS is connected to the propulsion shaft downstream from the propulsion source and the controllable disconnect.

In some examples, including in at least one preferred example, optionally, the vehicle further comprises a vehicle processing circuitry configured to cause the controllable disconnect to disconnect the propulsion source from the propulsion shaft responsive to obtaining a recuperation indication indicating that the vehicle is to operate at an enforced energy recuperation mode.

According to a third aspect, a method is presented. The method is a method of distributing energy of an internal energy storage device of an energy recovery system according to the first aspect when comprised in a vehicle. The method comprises obtaining an energy level of a non-propulsion battery connected to the energy recovery system. The method further comprises distributing energy from the internal energy storage device to a propulsion shaft of the vehicle and/or to the non-propulsion battery based on the energy level of the non-propulsion battery.

In some examples, including in at least one preferred example, optionally, distributing energy from the internal energy storage device comprises distributing energy from the internal energy storage device to the non-propulsion battery and to prevent distribution of energy from the internal energy storage device to the propulsion shaft of the vehicle responsive to the energy level of the non-propulsion battery being below a first threshold.

In some examples, including in at least one preferred example, optionally, distributing energy from the internal energy storage device further comprises distributing energy from the internal energy storage device to the propulsion shaft of the vehicle responsive to the energy level of the non-propulsion battery being above the first threshold.

In some examples, including in at least one preferred example, optionally, the method further comprises, responsive to the energy level of the non-propulsion battery being above a second threshold indicating a higher energy level than the first threshold, distributing energy from the internal energy storage device to the propulsion shaft of the vehicle, and preventing distribution of energy from the internal energy storage device to the propulsion shaft of the vehicle.

In some examples, including in at least one preferred example, optionally, distributing energy from the internal energy storage device further comprises distributing energy from the internal energy storage device to the non-propulsion battery and to the propulsion shaft of the vehicle responsive to the energy level of the non-propulsion battery being between the first and second thresholds.

The disclosed aspects, examples (including any preferred examples), and/or accompanying claims may be suitably combined with each other as would be apparent to anyone of ordinary skill in the art. Additional features and advantages are disclosed in the following description, claims, and drawings, and in part will be readily apparent therefrom to those skilled in the art or recognized by practicing the disclosure as described herein.

There are also disclosed herein computer systems, control units, code modules, computer-implemented methods, computer readable media, and computer program products associated with the above discussed technical benefits.

### BRIEF DESCRIPTION OF THE DRAWINGS

Examples are described in more detail below with reference to the appended drawings.

FIG. 1 is a side view of an exemplary vehicle according to an example.

FIG. 2 is a partial schematic view of an exemplary vehicle according to an example.

FIG. 3 is a schematic view of an energy recovery system according to an example.

FIG. 4 is a schematic view of an energy recovery system according to an example.

FIG. 5 is a graph of energy level of a non-propulsion battery according to an example.

FIG. 6 is a schematic view of a method of distributing energy of an internal energy storage device according to an example.

FIG. 7 is a partial schematic view of a method of distributing energy of an internal energy storage device according to an example.

FIG. 8 is a flow chart of distributing energy of an internal energy storage device according to an example.

FIG. 9 is a schematic diagram of an exemplary computer system for implementing examples disclosed herein, according to one example.

### DETAILED DESCRIPTION

The detailed description set forth below provides information and examples of the disclosed technology with sufficient detail to enable those skilled in the art to practice the disclosure.

Modern vehicles generally utilize a significant number of electrically powered devices. Fuel injection systems and monitoring systems of a vehicle run on electricity and require electrical power to function. These systems may be powered by a first electrical power source of the vehicle, a first battery. The first battery may be referred to as a vehicle management battery, a motor control battery, or an engine control battery. The first battery is configured to provide power to vehicle propulsion support functions. Some vehicles have elaborate comfort systems with not only temperature control but also refrigerators, microwave ovens etc., all powered by electricity. These systems may be powered by a second electrical power source of the vehicle, a second battery. The second battery may be referred to as a service battery, a living battery or a driver comfort battery. These power sources are generally different from a power source that is utilized to propel the vehicle and are referred to as non-propulsion batteries within the present disclosure.

In order to ensure that these non-propulsion batteries are powered, or least the first power source which is required to operate the vehicle, a generator (alternator) is generally provided to provide energy to the non-propulsion batteries. A generator in a vehicle is generally considered an important, or even essential, component of an electrical system of the vehicle. However, a generator adds weight and complexity to a vehicle's engine, may can reduce fuel efficiency and increase maintenance costs. A generator relies on the engine to produce power, which can lead to increased wear and tear on the engine. Generators may produce noise and vibration, which may be uncomfortable for passengers and may also indicate potential mechanical problems. Production and recycling of generators produce emissions and contribute to the overall carbon footprint of a vehicle.

The inventors behind the present disclosure have identified the shortcomings and drawbacks of the generator and endeavored to provide alternatives to this.

As previously indicated, energy efficiency of modern vehicles is an important area of improvement. Some vehicles incorporate a Kinetic Energy Recovery System (KERS) in order to preserve momentum and reduce fuel and/or energy consumption of a vehicle. A KERS is a mechanism that recovers the kinetic energy that is typically lost during braking of a vehicle. The KERS converts the recovered energy into a form that can be used to power the vehicle. KERS is may be used in any kind of vehicles, hybrid electric vehicles (HEVs), Formula One (F1) race cars and heavy-duty equipment have been known to incorporate KERS in their drivelines.

The KERS in a vehicle generally comprises several components, such as an electric motor/generator, a battery pack, and a control unit. When an operator of the vehicle applies brakes of the vehicle, the kinetic energy of the vehicle is converted into electrical energy by the motor/generator, which is then stored in the battery pack. When the driver accelerates, the KERS may use the stored electrical energy to provide a boost of power to the engine, which increases the overall performance and efficiency of the vehicle.

In F1 race cars, KERS is used to provide a short burst of extra power during overtaking maneuvers, which can make a significant difference in the outcome of a race. In HEVs and heavy-duty vehicles, KERS may help to improve fuel efficiency by reducing the load on an engine of the vehicle and by providing additional power during acceleration.

Overall, a KERS is an effective way to improve the efficiency and performance of a vehicle by recovering the kinetic energy that is typically lost during braking and using it to provide a boost of power during acceleration. A KERS is arranged to work in conjunction with a main propulsion source of a vehicle.

A KERS should not be confused with energy recuperation using a propulsion motor of a vehicle. The KERS is an additional arrangement that is considerably smaller, lighter and cheaper than a general electric propulsion source or combustion propulsion source. The general electric propulsion source or the combustion propulsion source is powerful enough to accelerate a vehicle to a wanted speed and provide sufficient power (torque) to maintain the wanted speed. A KERS is considerably less powerful and is generally utilized to provide an additional power surge during accelerations etc. Not only is a maximum power deliverable by a KERS significantly smaller than a power deliverable by the general electric propulsion source or the combustion propulsion source, an energy available from the KERS is also considerably lower than an energy available from the general electric propulsion source or the combustion propulsion source. This means that a maximum available energy of an energy storage device for (or of) the KERS is considerably smaller than a maximum available energy of an energy storage device for the general electric propulsion source or the combustion propulsion source.

Generally, a KERS is arranged, configured and/or adapted to only recuperate energy during breaking. In contrast, a general hybrid electric vehicle, or plug-in hybrid electric vehicle, may charge an energy storage for the electric motor from the combustion engine, e.g. at stand-still.

An energy capacity of a storage device of a KERS is generally below 10 kWh, or, in some examples, below 5 kWh.

A maximum power deliverable by a KERS is generally below 1/10 of a total propulsion energy of a vehicle. A maximum power deliverable of a KERS of a truck is generally below 100 KW, or, in some examples, below 75 kW.

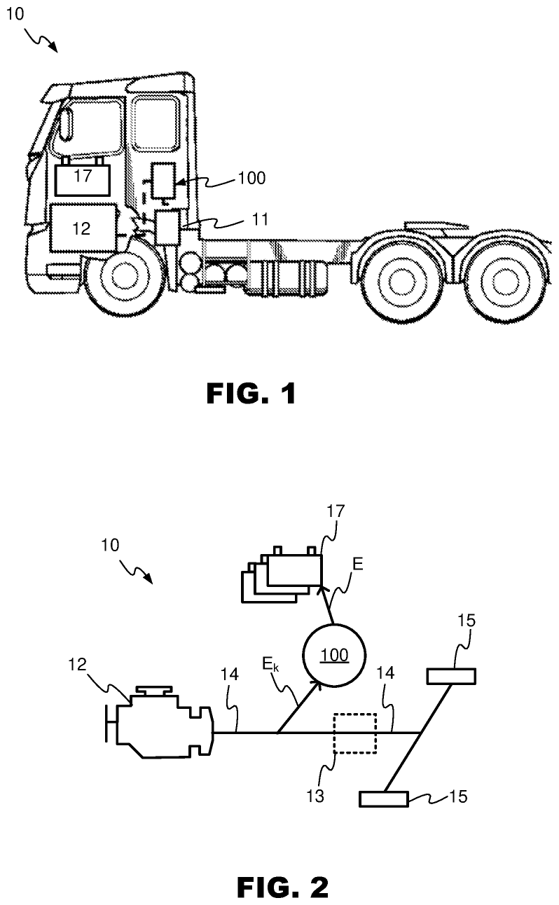

In FIG. 1, a vehicle 10 in the form of a truck is shown. The vehicle 10 is an exemplary view of a vehicle 10, and the skilled person will appreciate that the teachings of the present disclosure may be applied to any suitable vehicle 10 and not only the truck of FIG. 1.

The vehicle 10 comprises an energy recovery system 100 configured to recover kinetic energy of the vehicle 10. The vehicle 10 further comprises a propulsion source 12 that may be a combustion engine, an electrical motor or a combination thereof. The vehicle 10 advantageously comprises a vehicle processing circuitry 11 configured control or cause control of at least some operation of the vehicle 10. The vehicle processing circuitry 11 is advantageously operatively connected to at least the energy recovery system 100. The vehicle 10 further comprises at least one non-propulsion battery 17. The non-propulsion battery 17 is configured to provide power to any system and device of the vehicle 10 except the propulsion source 12. If the propulsion source 12 is a combustion engine, the combustion engine will be powered by fuel and the non-propulsion battery 17 may be configured to power e.g. circuitry, systems and/or devices controlling the combustion engine and/or comfort systems of the vehicle. If the propulsion source 12 is an electrical motor, the electric motor will be powered by a propulsion battery of the vehicle 10. The non-propulsion battery 17 may be configured to power e.g. circuitry, systems and/or devices controlling the electric motor and/or comfort systems of the vehicle.

The propulsion battery is generally a battery having a significantly higher nominal voltage than the non-propulsion battery. Generally, a propulsion battery may have a nominal voltage of a few hundred volts while the non-propulsion battery 17 is generally configured with a nominal voltage below 50V, preferably below 30 V. Generally, a truck is provided with non-propulsion batteries having a nominal voltage of 24 V, or rather, the truck may be provided with one or more pairs of non-propulsion batteries having a nominal voltage of 12 V connected in series. A general car may be provided with a non-propulsion battery having a nominal voltage of 12 V.

In FIG. 2, a schematic view of the arrangement of some of the components of the vehicle 10 is shown. The skilled person will appreciate the schematic view of FIG. 2 is, for efficiency of disclosure, simplified and focus on the features that are most relevant to the present disclosure. In FIG. 2, the vehicle 10 comprises the energy recovery system 100 which will be further explained in later sections of the present disclosure. The vehicle 10 further comprises one or more non-propulsion batteries 17. The non-propulsion batteries 17 may be any suitable non-propulsion battery 17 described herein. The vehicle 10 further comprises a propulsion source 12, in FIG. 2 shown as a combustion engine, but as previously indicated, any suitable propulsion source 12 may be utilized with the teachings of the present disclosure. The propulsion source 12 is propelling a propulsion shaft 14 of the vehicle 10. The propulsion shaft transfers the propelling from the propulsion source 12 to wheels 15 of the vehicle 10. It should be mentioned that also belt drives may be utilized with the teachings of the present disclosure. The energy recovery system 100 is configured to obtain energy Eₖ from the propulsion shaft 14. The energy from the propulsion shaft 14 is kinetic energy Eₖ. The energy recovery system 100 is configured to convert the kinetic energy Eₖ from the propulsion shaft 14 to electrical energy E and provide the electrical energy E to the non-propulsion battery 17.

By the arrangement of the vehicle 10 illustrated in FIG. 10, the energy recovery system 100 may charge the non-propulsion battery 17 and replace a generator of the vehicle 10. As mentioned above, this provides significant benefits for the vehicle 10 with regards to e.g., cost, quality and fuel efficiency (reduced weight).

In FIG. 2, an optional disconnect 13 is provided in serial to the propulsion shaft 14. The disconnect 13 may be a clutch or other suitable disconnect device arranged to disconnect the propulsion source 12 from the wheels 15. That is to say, the propulsion source 12 may be selectively connected to the propulsion shaft 14 of the vehicle 10. As will be explained in later sections, the disconnect 13 may be utilized to force kinetic energy Eₖ to be provided to the energy recovery system 100 without propelling the vehicle 10. The disconnect 13 is advantageously controlled by the vehicle control circuit 11.

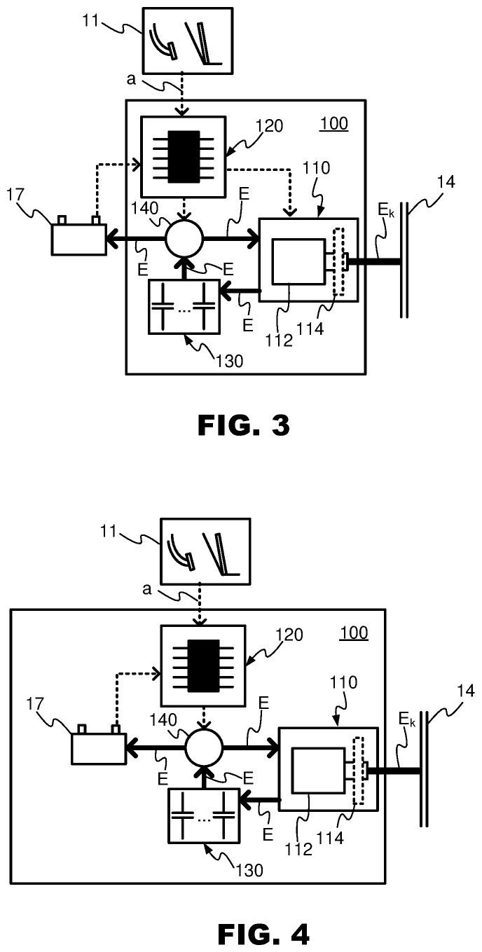

In FIG. 3, a schematic view of an energy recovery system 100 according to some examples of the present disclosure is shown. The energy recovery system 100 comprises a KERS 110 configured to be connected to the propulsion shaft 14 of the vehicle 10. That is to say, the KERS 110 is arranged to obtain kinetic energy Eₖ to the propulsion shaft 14 and to provide kinetic energy Eₖ to the propulsion shaft 14 depending on a mode of operation of the energy recovery system 100.

The KERS comprises an electrical motor 112 arranged to (i.e. configured to, adapted to) convert kinetic energy Eₖ from the propulsion shaft 14 to electric energy E and to convert electric energy to kinetic energy Eₖ for the propulsion shaft 14 depending on a mode of operation of the KERS 110.

The KERS may in some examples comprise a flywheel arrangement 114 considered to store kinetic energy Eₖ as kinetic energy Eₖ. Adding a flywheel arrangement 114 to a KERS 110 in a vehicle 10 may provide several benefits, including improved performance, fuel efficiency, and reduced emissions. The flywheel arrangement 114 is able to store a comparable large amount of energy in a comparable small volume, making it an efficient and practical option for the KERS 110. The stored energy may be quickly released when needed, providing a burst of power to the vehicle 10. The flywheel 114 arrangement may very well be combined with other examples and/or features presented herein. Kinetic energy Eₖ of the flywheel 110 may be converted to electric energy E and provided to the energy storage device 130.

The energy recovery system 100 of FIG. 3 further comprises a processing circuitry 120. The processing circuitry 120 is configured to control operation of the KERS 110 and the energy recovery system 100.

In FIG. 3, the energy recovery system 100 further comprises an energy storage device 130. The energy storage device 130 is an electrical energy storage device and is arranged to store energy recovered by the KERS 110. The kinetic energy Eₖ recovered by the KERS 110 is converted to electrical energy E by the electrical motor 112 of the KERS 110 and provided to the energy storage device 130 for later use.

The energy storage device 130 may be any energy storage device 130 suitable for storing electrical energy. The energy storage device 130 may be any suitable energy storage device such as a capacitor or a battery. A rechargeable battery provide energy storage in a chemical form and may be recharged many times. Different types of batteries include lead-acid, nickel-cadmium, nickel-metal hydride, and lithium-ion batteries which are all well known to the skilled person. In an advantageous example, the energy storage device 130 comprises one more super capacitors. Super capacitors, also known as ultracapacitors, are energy storage devices 130 that are able to store and release electrical energy E comparably quickly and efficiently. Super capacitors are configured to deliver high power densities, which means that super capacitors may provide a large amount of power in a short amount of time. This makes them ideal for applications that require a burst of energy, such as electric vehicles, hybrid electric vehicles, and industrial equipment. The speed of energy delivery is mimicked in energy reception of super capacitors. Super capacitors can charge and discharge quickly, which means they can store and release energy much faster than traditional batteries. This makes them useful for applications that require rapid energy transfer, such as the present energy recovery system 100. Further to this, super capacitors have an extended cycle life, which means that they may be charged and discharged many times without degradation of their performance. Super capacitors do not require periodic deep cycling or equalization, and they have a lower risk of leakage or other issues compared to batteries. Additionally, super capacitors may operate over an extended temperature range, which makes them suitable also for use in extreme environments.

In some examples, the energy storage device 130 stores energy in a non-electric form. In the following, some examples are presented and the skilled person will appreciate that the energy storage device 130 further comprises energy conversion circuitry configured to convert the stored energy into electric energy E. In one example, the energy storage device 130 stores energy in the form of kinetic energy Eₖ. This may be provided by incorporating a flywheel in the energy storage device 130. In one example, the energy storage device 130 stores energy by increasing a pressure of a container. This may be provided by incorporating a Compressed air energy storage (CAES) in the energy storage device 130.

The energy recovery system 100 may further comprise a power control circuitry 140. The power control circuitry 140 is an electric circuit configured to control the power of the energy recovery system 100. It may be that a voltage level provided by the KERS 110 to the energy storage device 130 differs from a voltage level of the non-propulsion battery 17. In such examples, the power control circuitry may comprise a voltage converter such as a DC to DC converter. The power control circuitry 140 may comprise charging circuitry configured to provide suitable charging currents for the non-propulsion battery 17. The power control circuitry 140 may comprise motor control circuitry configured to drive the electrical motor 112 of the KERS 110. The power control circuitry 140 may further, or alternatively, comprise suitable switches, relays, sensors and/or safety devices for ensuring that the flow of energy E in the energy recovery system 100 is accurate, reliable and safe.

In some examples, the power control circuitry 140 may comprise the processing circuitry 120, or the processing circuitry 120 may comprise the power control circuit 140.

In FIG. 4, an alternative example of the energy recovery system 100 is shown. The example of FIG. 4 differs from the example of FIG. 3 in that the energy recovery system 100 of FIG. 4 comprises one or more non-propulsion batteries 17.

The energy recovery system 100 is configured to provide energy E to the non-propulsion battery 17 of the vehicle 10 or of the energy recovery system 100. The processing circuitry 120 is configured to cause control of distribution of energy E from the energy storage device 130. As indicated above, the energy E of the energy storage device 130 may provide energy E to the non-propulsion battery 17 of the vehicle 10, i.e. charge the non-propulsion battery and/or to the propulsion shaft 14 of the vehicle, i,e, to the KERS 110 for conversion to kinetic energy Eₖ provided to the propulsion shaft 14.

As will be explained in greater detail in the following, the distribution of energy E may be based on one or more indicators, values or controls obtained by the energy recovery system 100. One such parameter is an energy level E₁₇ (see FIG. 5) of the non-propulsion battery 17.

In FIG. 5, a graph of an energy level E₁₇ of the non-propulsion battery 17 is shown. It should be mentioned that, when the energy level E₁₇ of the non-propulsion battery 17 is referenced, this does not, as the skilled person will appreciate, necessarily relate to a specific energy level, but may advantageously relate to in indication of a relative or specific energy level. The energy level E₁₇ may be a percentage indicating a state of charge (SOC), a current voltage level in relation to minimum and maximum voltage levels of the non-propulsion battery 17.

A common way to measure the SOC or energy level of a battery is by measuring its voltage. As the battery discharges, the voltage drops. So, by measuring the voltage, the SOC of the battery may be estimated. However, the relationship between voltage and state of charge is not linear, and it may, as the skilled person knows, vary depending on the type of battery and the load it is powering. The energy level may be estimated by the specific gravity of an electrolyte of the non-propulsion battery 17. The specific gravity is a measure of the density of a liquid. In lead-acid batteries which are a common type of non-propulsion batteries 17 for vehicles, the electrolyte's specific gravity changes as the battery charges and discharges. A hydrometer may be used to measure the specific gravity of the electrolyte, and this may be used to determine the energy level of the battery. The energy level E₁₇ of the non-propulsion battery 17 may be estimated by monitoring an amount of charge that flows into or out of the non-propulsion battery 17. This may be referred to as coulomb counting. By keeping track of the amount of charge that has been added or removed from the non-propulsion battery 17, the energy level E₁₇ of the non-propulsion battery 17 may be estimated. The energy level E₁₇ of the non-propulsion battery 17 may be estimated by determining an impedance of the non-propulsion battery 17. As a battery discharges, its impedance changes, and the energy level E₁₇ of the non-propulsion battery 17 may be estimated. The above listed methods of determining the energy level E₁₇ of the non-propulsion battery 17 are exemplary and other suitable methods or devices may very well be employed. In order to increase an accuracy of the measured/estimated/determined energy level E₁₇ of the non-propulsion battery 17, a combination of methods may be employed.

In FIG. 5, the energy level E₁₇ of the non-propulsion battery 17 is varying over time t. The energy level E₁₇ of the non-propulsion battery 17 is obtained by the processing circuitry 120 of the energy recovery system 100. The processing circuitry 120 is configured to control operation of the energy recovery system 100 based on the energy level E₁₇ of the non-propulsion battery 17. The energy level E₁₇ of the non-propulsion battery 17 will determine which region of operation (i), (ii), (iii), (iv) the energy recovery system will operate at. In FIG. 5, four main regions of operation (i), (ii), (iii), (iv) are shown.

The energy recovery system 100 is configured to operate at a first region of operation (i) responsive to the energy level E₁₇ of the non-propulsion battery 17 being below a first threshold T₁ and above a minimum threshold Tₘᵢₙ. The first region (i) is the leftmost region in FIG. 5. The first region of operation (i) may advantageously indicate that the energy level E₁₇ of the non-propulsion battery 17 is such that the non-propulsion battery 17 has sufficient energy to reliably manage to provide power to e.g. engine control functionality or other functionality required to propel the vehicle 10. At the first region of operation (i), the energy E from the energy storage device 130 is provided to the non-propulsion battery 17 in order to increase the energy level E₁₇ of the non-propulsion battery 17. This means that the energy E recovered by the KERS 110 is utilized to charge to the non-propulsion battery 17. At the first region of operation (i), no energy E is provided to the KERS 110 even if the operator of the vehicle 10 accelerates the vehicle 10. The first region of operation (i) reduces a risk that the non-propulsion battery 17 is discharged below the minimum threshold Tₘᵢₙ. If the energy level E₁₇ of the non-propulsion battery 17 falls below the minimum threshold Tₘᵢₙ, the non-propulsion battery may not be able to reliably provide power to e.g. engine control functionality or other functionality required to propel the vehicle 10.

The energy recovery system 100 is configured to operate at a second region of operation (ii) responsive to the energy level E₁₇ of the non-propulsion battery 17 being below a second threshold T₂ and above the first threshold T₁. The second region (ii) is the second leftmost region in FIG. 5. The second region of operation (ii) may advantageously indicate that the energy level E₁₇ of the non-propulsion battery 17 is such that the non-propulsion battery 17 has sufficient energy, with margin, to reliably manage to provide power to e.g. engine control functionality or other functionality required to propel the vehicle 10. At the second region of operation (ii) it is not critical to charge the non-propulsion battery 17. However, the non-propulsion battery 17 is not fully charged and it is advantageous to charge the non-propulsion battery 17 at least partly at the second region of operation (ii). To this end, at the second region of operation (ii), the energy recovery system 100 is configured to provide a portion of the energy E from the energy storage device 130 to the non-propulsion battery 17 to charge the non-propulsion battery 17. The energy recovery system 100 is further configured to provide a portion of the energy E from the energy storage device 130 to the KERS 110 to provide kinetic energy Eₖ to the propulsion shaft 14 (when requested).

At the second region of operation (ii), the sharing of energy E between the non-propulsion battery 17 and the KERS 110 may be in equal parts, i.e. 50% to the non-propulsion battery 17 and 50% to the KERS 110. In some examples, the split is in favor of the KERS 110 such that a portion of the energy E provided to the KERS 110 is greater than a portion of energy E provided to the non-propulsion battery 17. Advantageously, 40% of the energy of the energy storage device 130 is provided to the non-propulsion battery 17 and 60% of the energy of the energy storage device 130 is provided to the KERS 11.

The energy recovery system 100 is configured to operate at a third region of operation (iii) responsive to the energy level E₁₇ of the non-propulsion battery 17 being above the second threshold T₂. The third region (ii) is the second rightmost region in FIG. 5. The third region of operation (iii) may advantageously indicate that the energy level E₁₇ of the non-propulsion battery 17 is such that the non-propulsion battery 17 is fully, or close to fully charged. At the third region of operation (iii), the non-propulsion battery 17 may not be capable of further charging (trickle charging or maintenance charging excluded). To this end, at the third region of operation (iii), the energy recovery system 100 is configured to provide the energy E from the energy storage device 130 to the KERS 110 to provide kinetic energy Eₖ to the propulsion shaft 14 (when requested).

With the first three regions of operation (i), (ii), (iii) explained, it may be concluded that, at the first region of operation (i), 100% of the recovered energy E of the energy storage device 130 is provide to the non-propulsion battery 17. Further, at the third region of operation (iii), 100% of the recovered energy E of the energy storage device 130 is provide to the KERS 110. In some examples, at the second region of operation (ii), the split in distribution of energy E is sliding from substantially 100% in favor of the non-propulsion battery 17 at the first threshold T₁, to substantially 100% in favor of the KERS 110 at the second threshold T₂. A sliding split of energy E provided to the non-propulsion battery 17 and the KERS 110 is advantageous as a risk of energy spikes (i.e. current spikes) duc to switching between the regions of operation is reduced.

It may be that, due to self-discharge, malfunction, elevated power consumption at idle etc., the energy level E₁₇ of the non-propulsion battery 17 is below the minimum threshold Tₘᵢₙ. At this low energy level E₁₇ of the non-propulsion battery 17 the energy recovery system 100 is configured to operate at a fourth region of operation (iv). This is indicated by the rightmost region in FIG. 5. At the fourth region of operation (iv), the energy recovery system 100 is configured to prohibit energy E to be transferred to the KERS 110. Further, at the fourth region of operation (iv), in prohibit the vehicle 10 to be propelled (i.e. driven), the energy recovery system 100 may be configured to alert the vehicle 10, or an operator of the vehicle 10, that operation of the vehicle 10 is prohibited at least until the energy level E₁₇ of the non-propulsion battery 17 is above the minimum threshold Tₘᵢₙ. TO this end, the energy recovery system 100 may be configured to provide a recuperation indication to the vehicle 10. Responsive to obtaining the recuperation indication, the vehicle 10 may be configured to e.g., activate the disconnect 13 such that the propulsion source 12 may provide kinetic energy Eₖ to the KERS 110. The KERS 110 will recuperate the kinetic energy Eₖ and provide electric energy E to the energy storage device 130. The energy of the energy storage device 130 is then distributed to the non-propulsion battery 17 by the control circuit 120.

The above fourth region of operation (iv) ensures that the non-propulsion battery 17 may be charged even if the vehicle 10 is not moving. This reduces a risk that the vehicle 10 is operated at times when the non-propulsion battery 17 is at a too low energy level. If the vehicle is operated when the non-propulsion battery 17 is at a too energy level, this may result in malfunction of control electronics of the vehicle 10 leading to increased fuel consumption due to improper ignition and/or injection control which may damage the vehicle 10 or reduce road safety of the vehicle 10.

As will be further explained in later sections of the present disclosure, the distribution of energy E from the energy storage device 130 may depend on further indicators. One exemplary indicator is an acceleration indicator a, see FIG. 3 and FIG. 4. The acceleration indicator a may be obtained from controls 11, see FIG. 3 and FIG. 4, of the vehicle 10, e.g. an accelerator, a brake pedal, a cruise control etc. The acceleration indicator a is advantageously configured to indicate a wanted acceleration of the vehicle 10. To exemplify, if the acceleration indicator a is positive, more kinetic energy Eₖ is requested for the propulsion shaft 14 of the vehicle 10. If the acceleration indicator a is positive, the energy recovery system 100 may be configured to, if operating at the second or third region of operation (ii), (iii) distribute energy E to the KERS 110. However, if the acceleration indicator a is negative, the kinetic energy Eₖ of the propulsion shaft 14 is to be reduced. In this case, energy is provided form the KERS 110 to the energy storage device and the energy recovery system 100 is prevented from distributing energy E to the KERS 110 regardless of the region of operation (i), (ii), (iii), (iv) the energy recovery system 100 is operating at.

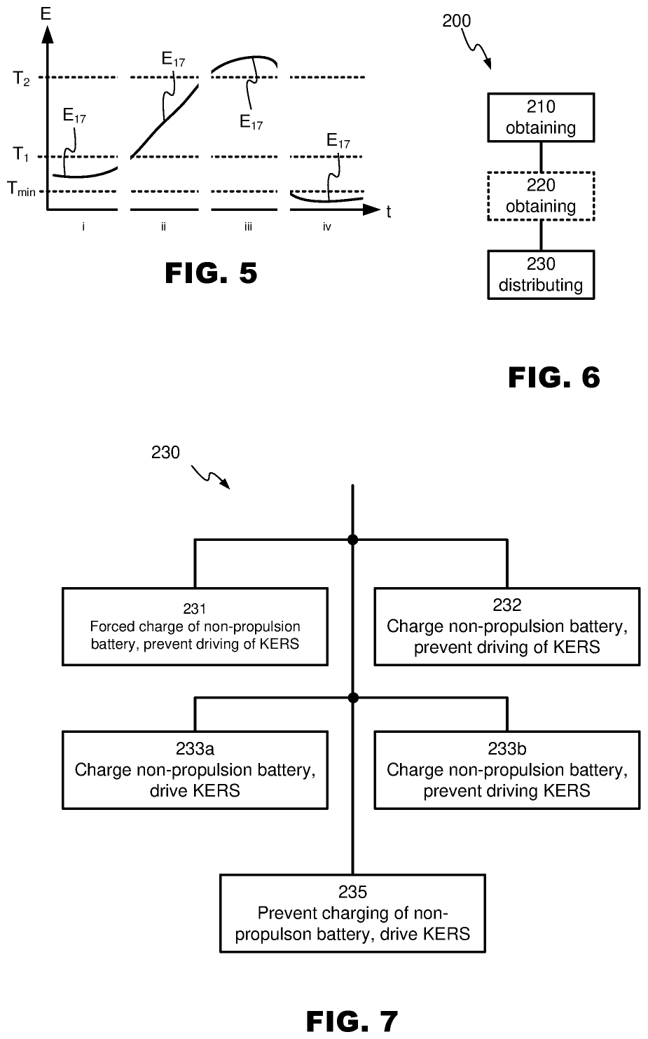

In FIG. 6, a block diagram of a method 200 of distributing energy E is shown. The method 200 is suitable for implementation in a vehicle 10 for distributing energy E stored in the energy storage device 130 as previously presented. The method 200 will be briefly described, but it should be emphasized that the method 200 may very well be extended to further comprise any suitable features or examples presented herein. Execution of the method 200 is advantageously caused or performed by the processing circuitry 120 of the energy recovery system 100 presented herein. However, execution of the method 200 may be performed or caused by any suitable processing circuitry or collection/distribution of processing circuitry and is not limited to execution by the processing circuitry 120 of the energy recovery system 100.

The method 200 comprises obtaining 210 an energy level E₁₇ of a non-propulsion battery 17. The non-propulsion battery 17 is advantageously a non-propulsion battery 17 as presented in the present disclosure, but may be any suitable non-propulsion battery 17. The non-propulsion battery is directly or operatively connected to an energy recovery system 100, as presented herein.

The method 200 further comprises distributing 230 energy E from the energy storage device 130 to a propulsion shaft 14 of the vehicle 10 and/or to the non-propulsion battery 17 of the vehicle 10. The distributing 230 of energy E is, as previously presented, based on the energy level E₁₇ of the non-propulsion battery 17.

Optionally, in some examples, the method 200 further comprises obtaining 220 the previously presented acceleration indicator a from the vehicle 10. In such examples, the distributing of energy 230 is advantageously further based on the acceleration indicator a.

In FIG. 7, a detailed view of the distributing of energy 230 is shown. The distributing of energy 230 may optionally comprise preventing 233b distribution of energy E from the internal energy storage device 130 to the propulsion shaft 14 of the vehicle 10 if the acceleration indicator a indicates a negative acceleration of the vehicle 10. If the acceleration indicator a indicates a positive acceleration of the vehicle 10, the distributing of energy 230 may optionally comprise driving 233a, 235 the KERS 110.

As further shown in FIG. 7, the distributing 230 of energy E may optionally comprise distributing 231, 232 energy E from the internal energy storage device 130 to the non-propulsion battery 17 and to prevent distribution of energy E from the internal energy storage device 130 to the propulsion shaft 14 of the vehicle 10. As indicated with reference to FIG. 5, this is advantageously the case when the energy level E₁₇ of the non-propulsion battery 17 is below a first threshold T₁. That is to say, then the energy recovery system 100 is operating at the first or second region of operation (i), (ii).

In FIG. 7, the distributing 230 of energy E may optionally comprise distributing 233a, 233b energy E from the internal energy storage device 130 to the non-propulsion battery 17 and to, depending on e.g., the acceleration indicator a, drive the KERS 110.

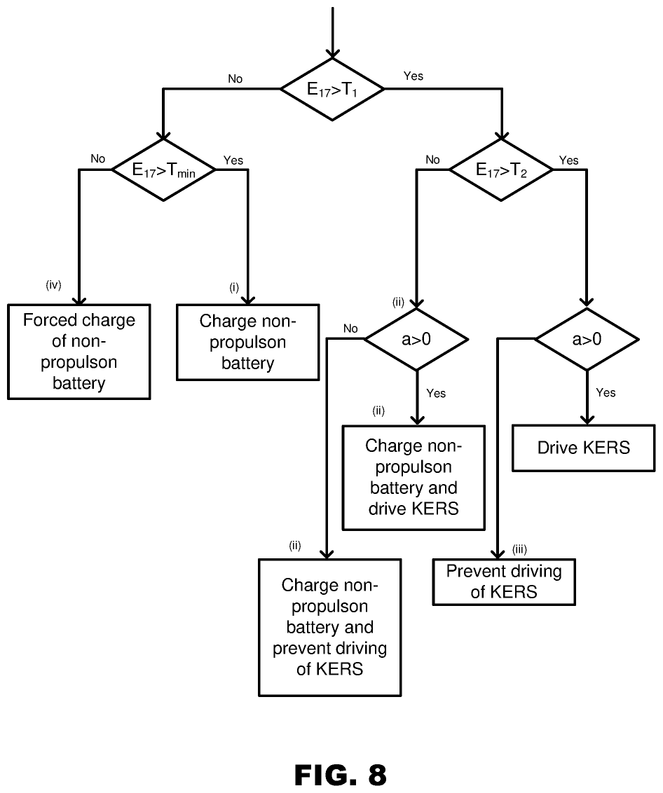

The method 200 will be further explained by the flow chart of FIG. 8. The flow chart of FIG. 8 shows an exemplary operation of the energy recovery system 100. Execution of the actions of the flow chart in FIG. 8 are advantageously caused or performed by the processing circuitry 120. The flow chart of FIG. 8 shows a number of comparisons between the energy level E₁₇ of the non-propulsion battery 17 and the different thresholds Tₘᵢₙ, T₁, T₂ introduced with reference to FIG. 5. The order of the comparisons of FIG. 8 is exemplary and should not be considered limiting. The skilled person will understand, after digesting the teachings of the present disclosure, how to reconfigure the order of the comparisons.

In FIG. 8, the energy level E₁₇ of the non-propulsion battery 17 is compared to the first threshold T₁. If the energy level E₁₇ of the non-propulsion battery 17 is below the first threshold T₁, the energy recovery system 100 is operating at the first region of operation (i) or the fourth region of operation (iv). To determine with of the first region of operation (i) or the fourth region of operation (iv) the energy recovery system 100 is operating at, the energy level E₁₇ of the non-propulsion battery 17 is compared to the minimum threshold Tₘᵢₙ. If the energy level E₁₇ of the non-propulsion battery 17 is below the minimum threshold Tₘᵢₙ, the energy recovery system 100 is operating at the fourth region of operation (iv), corresponding to feature 231 forced charge of non-propulsion battery, prevent driving of KERS in FIG. 7. If the energy level E₁₇ of the non-propulsion battery 17 is above the minimum threshold Tₘᵢₙ, the energy recovery system 100 is operating at the first region of operation (i), corresponding to feature 232 charge non-propulsion battery, prevent driving of KERS in FIG. 7.

If the energy level E₁₇ of the non-propulsion battery 17 is above the first threshold T₁, the energy recovery system 100 is operating at the second region of operation (ii) or the third region of operation (iii). To determine with of the second region of operation (ii) or the third region of operation (iii) the energy recovery system 100 is operating at, the energy level E₁₇ of the non-propulsion battery 17 is compared to the second threshold T₂. If the energy level E₁₇ of the non-propulsion battery 17 is below the second threshold T₂, the energy recovery system 100 is operating at the second region of operation (ii). At the second region of operation (ii), energy of the energy storage device 130 may be distributed to both the non-propulsion battery 17 and the KERS 110. In order to determine if energy E is to be distributed to the KERS 110 or not, the acceleration indicator a may be utilized. If the acceleration indicator a is negative, the energy recovery system 100 is configured to distribute energy E to the non-propulsion battery 17 and to prevent distribution of energy E to the KERS 110, compare to feature 233b charge non-propulsion battery, prevent driving KERS of FIG. 7. If the acceleration indicator a is positive, the energy recovery system 100 is configured to distribute energy E to the non-propulsion battery 17 and to the KERS 110, compare to feature 233a charge non-propulsion battery, drive KERS of FIG. 7.

If the energy level E₁₇ of the non-propulsion battery 17 is above the second threshold T₂, the energy recovery system 100 is operating at the third region of operation (iii). In order to determine if energy E is to be distributed to the KERS 110, the acceleration indicator a may be utilized. If the acceleration indicator a is positive, the energy recovery system 100 is configured to distribute energy E to the KERS 110, compare to feature 235 prevent charging of non-propulsion battery, drive KERS of FIG. 7. If the acceleration indicator a is negative, the energy recovery system 100 may configured to store energy E in the energy storage device 130, i.e. not to distribute energy E to either of the KERS 110 or the non-propulsion battery 17.

Optionally, if the last state occurs, i.e. the non-propulsion battery 17 is fully charged and there is no acceleration request, it may be that the energy storage device 130 is full or otherwise unable to hold more energy E. In order to prevent overcharging and/or voltage buildup, overcharging circuitry may be provided in the power control circuitry 140. The overcharging circuitry may comprise a resistor or other suitable device arranged to dissipate energy recovered from the KERS 110 if no other device is in need of energy E.

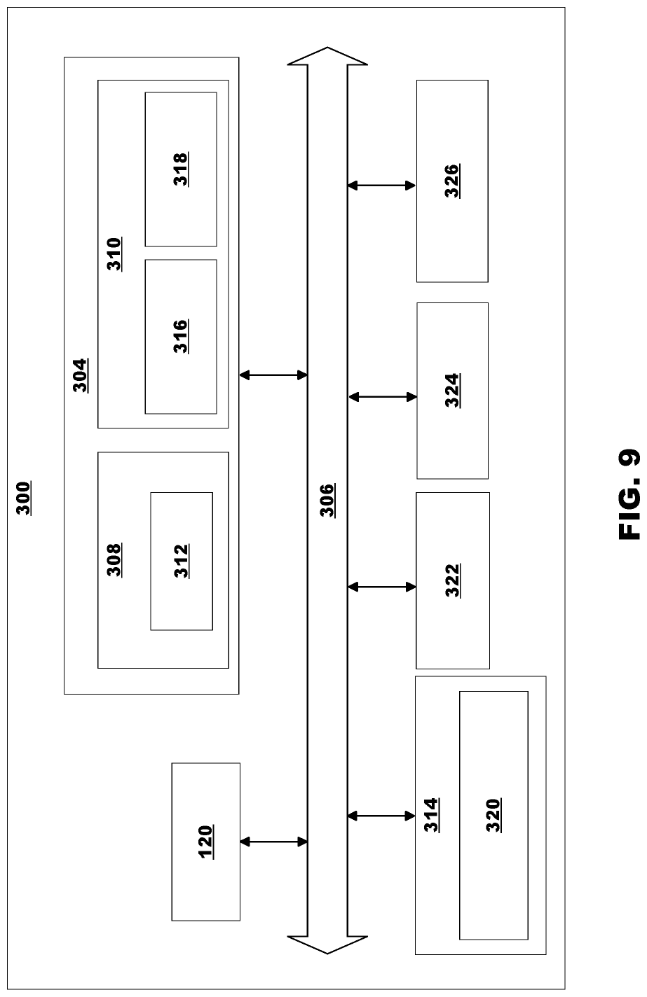

FIG. 9 is a schematic diagram of a computer system 300 for implementing examples disclosed herein. The computer system 300 is adapted to execute instructions from a computer-readable medium to perform these and/or any of the functions or processing described herein. The computer system 300 may be connected (e.g., networked) to other machines in a LAN, an intranet, an extranet, or the Internet. While only a single device is illustrated, the computer system 300 may include any collection of devices that individually or jointly execute a set (or multiple sets) of instructions to perform any one or more of the methodologies discussed herein. Accordingly, any reference in the disclosure and/or claims to a computer system, computing system, computer device, computing device, control system, control unit, electronic control unit (ECU), processor device, processing circuitry, etc., includes reference to one or more such devices to individually or jointly execute a set (or multiple sets) of instructions to perform any one or more of the methodologies discussed herein. For example, control system may include a single control unit or a plurality of control units connected or otherwise communicatively coupled to each other, such that any performed function may be distributed between the control units as desired. Further, such devices may communicate with each other or other devices by various system architectures, such as directly or via a Controller Area Network (CAN) bus, etc.

The computer system 300 may comprise at least one computing device or electronic device capable of including firmware, hardware, and/or executing software instructions to implement the functionality described herein. The computer system 300 may include processing circuitry 120 (e.g., processing circuitry including one or more processor devices or control units), a memory 304, and a system bus 306. The computer system 300 may include at least one computing device having the processing circuitry 120. The system bus 306 provides an interface for system components including, but not limited to, the memory 304 and the processing circuitry 120. The processing circuitry 120 may include any number of hardware components for conducting data or signal processing or for executing computer code stored in memory 304. The processing circuitry 120 may, for example, include a general-purpose processor, an application specific processor, a Digital Signal Processor (DSP), an Application Specific Integrated Circuit (ASIC), a Field Programmable Gate Array (FPGA), a circuit containing processing components, a group of distributed processing components, a group of distributed computers configured for processing, or other programmable logic device, discrete gate or transistor logic, discrete hardware components, or any combination thereof designed to perform the functions described herein. The processing circuitry 120 may further include computer executable code that controls operation of the programmable device.

The system bus 306 may be any of several types of bus structures that may further interconnect to a memory bus (with or without a memory controller), a peripheral bus, and/or a local bus using any of a variety of bus architectures. The memory 304 may be one or more devices for storing data and/or computer code for completing or facilitating methods described herein. The memory 304 may include database components, object code components, script components, or other types of information structure for supporting the various activities herein. Any distributed or local memory device may be utilized with the systems and methods of this description. The memory 304 may be communicably connected to the processing circuitry 120 (e.g., via a circuit or any other wired, wireless, or network connection) and may include computer code for executing one or more processes described herein. The memory 304 may include non-volatile memory 308 (e.g., read-only memory (ROM), erasable programmable read-only memory (EPROM), electrically erasable programmable read-only memory (EEPROM), etc.), and volatile memory 310 (e.g., random-access memory (RAM)), or any other medium which can be used to carry or store desired program code in the form of machine-executable instructions or data structures and which can be accessed by a computer or other machine with processing circuitry 120. A basic input/output system (BIOS) 312 may be stored in the non-volatile memory 308 and can include the basic routines that help to transfer information between elements within the computer system 300.

The computer system 300 may further include or be coupled to a non-transitory computer-readable storage medium such as the storage device 314, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 314 and other drives associated with computer-readable media and computer-usable media may provide non-volatile storage of data, data structures, computer-executable instructions, and the like.

Computer-code which is hard or soft coded may be provided in the form of one or more modules. The module(s) can be implemented as software and/or hard-coded in circuitry to implement the functionality described herein in whole or in part. The modules may be stored in the storage device 314 and/or in the volatile memory 310, which may include an operating system 316 and/or one or more program modules 318. All or a portion of the examples disclosed herein may be implemented as a computer program 320 stored on a transitory or non-transitory computer-usable or computer-readable storage medium (e.g., single medium or multiple media), such as the storage device 314, which includes complex programming instructions (e.g., complex computer-readable program code) to cause the processing circuitry 120 to carry out actions described herein. Thus, the computer-readable program code of the computer program 320 can comprise software instructions for implementing the functionality of the examples described herein when executed by the processing circuitry 120. In some examples, the storage device 314 may be a computer program product (e.g., readable storage medium) storing the computer program 320 thereon, where at least a portion of a computer program 320 may be loadable (e.g., into a processor) for implementing the functionality of the examples described herein when executed by the processing circuitry 120. The processing circuitry 120 may serve as a controller or control system for the computer system 300 that is to implement the functionality described herein.

The computer system 300 may include an input device interface 322 configured to receive input and selections to be communicated to the computer system 300 when executing instructions, such as from a keyboard, mouse, touch-sensitive surface, etc. Such input devices may be connected to the processing circuitry 120 through the input device interface 322 coupled to the system bus 306 but can be connected through other interfaces, such as a parallel port, an Institute of Electrical and Electronic Engineers (IEEE) 1394 serial port, a Universal Serial Bus (USB) port, an IR interface, and the like. The computer system 300 may include an output device interface 324 configured to forward output, such as to a display, a video display unit (e.g., a liquid crystal display (LCD) or a cathode ray tube (CRT)). The computer system 300 may include a communications interface 326 suitable for communicating with a network as appropriate or desired.

The operational actions described in any of the exemplary aspects herein are described to provide examples and discussion. The actions may be performed by hardware components, may be embodied in machine-executable instructions to cause a processor to perform the actions, or may be performed by a combination of hardware and software. Although a specific order of method actions may be shown or described, the order of the actions may differ. In addition, two or more actions may be performed concurrently or with partial concurrence.

In the following, a list of examples are presented.

Example 1. An energy recovery system 100 for a vehicle 10, the energy recovery system 100 comprises a Kinetic Energy Recovery System, KERS, 110 for connecting to a propulsion shaft 14 of the vehicle 10, an internal energy storage device 130 arranged to receive and store energy from the KERS 110, and a processing circuitry 120 configured to cause distribution of energy E from the internal energy storage device 130 to the propulsion shaft 14 of the vehicle 10 and/or at least one non-propulsion battery 17 for the vehicle 10 based on an energy level E₁₇ of the non-propulsion battery 17.

Example 2. The energy recovery system 100 of example 1, wherein the processing circuitry 120 is further configured to cause distribution of energy E from the internal energy storage device 130 based on an acceleration indicator 11 obtained from the vehicle 10.

Example 3. The energy recovery system 100 of example 2, wherein the processing circuitry 120 is configured to prevent distribution of energy E from the internal energy storage device 130 to the propulsion shaft 14 of the vehicle 10 responsive to the acceleration indicator 11 indicating a negative acceleration of the vehicle 10.

Example 4. The energy recovery system 100 of any one of the preceding examples, wherein the internal energy storage device 130 is a super capacitor.

Example 5. The energy recovery system 100 of the preceding examples, wherein the processing circuitry 120 is further configured to cause distribution of energy E from the internal energy storage device 130 to the non-propulsion battery 17 and to prevent distribution of energy E from the internal energy storage device 130 to the propulsion shaft 14 of the vehicle 10 responsive to the energy level E₁₇ of the non-propulsion battery 17 being below a first threshold T₁.

Example 6. The energy recovery system 100 of example 5, wherein the processing circuitry 120 is further configured to cause distribution of energy E from the internal energy storage device 130 to the propulsion shaft 14 of the vehicle 10 responsive to the energy level E₁₇ of the non-propulsion battery 17 being above the first threshold T₁.

Example 7. The energy recovery system 100 of example 5 or 6, wherein the processing circuitry 120 is further configured to cause distribution of energy E from the internal energy storage device 130 to the propulsion shaft 14 of the vehicle 10 and to prevent distribution of energy E from the internal energy storage device 130 to the non-propulsion battery 17 responsive to the energy level E₁₇ of the non-propulsion battery 17 being above a second threshold T₂, wherein the second threshold T₂ is indicating a higher energy level E₁₇ than the first threshold T₁.

Example 8. The energy recovery system 100 of example 6 or 7, wherein the processing circuitry 120 is further configured to cause distribution of energy E from the internal energy storage device 130 to the non-propulsion battery 17 and to the propulsion shaft 14 of the vehicle 10 responsive to the energy level E₁₇ of the non-propulsion battery 17 being between the first and second thresholds.

Example 9. The energy recovery system 100 of any one of the preceding examples, wherein the processing circuitry 120 is further configured to provide a recuperation indication to the vehicle 10 indicating that the vehicle 10 is to operate at an enforced energy recuperation mode.

Example 10. The energy recovery system 100 of example 5 and 9, wherein the processing circuitry 120 is configured to provide the recuperation indication to the vehicle 10 responsive to the energy level E₁₇ of the non-propulsion battery 17 being below a minimum threshold Tₘᵢₙ, wherein the minimum threshold Tₘᵢₙ is below the first threshold T₁.

Example 11. The energy recovery system 100 of any one of the preceding examples, further comprising the at least one non-propulsion battery 17.

Example 12. The energy recovery system 100 of example 11, further comprising at least two non-propulsion batteries 17, wherein a first non-propulsion battery 17 is configured for providing power to vehicle propulsion control and a second non-propulsion battery 17 is configured for providing power to vehicle comfort control.

Example 13. The energy recovery system 100 of example 11 or 12, wherein at least one non-propulsion battery 17 is a battery configured with a nominal voltage below 30 V.

Example 14. The energy recovery system 100 of any one of the preceding examples, wherein the KERS 110 comprises an electrical motor 112.

Example 15. The energy recovery system 100 of example 14, wherein the KERS 110 comprises a flywheel arrangement 114.

Example 16. The energy recovery system 100 of example 1, wherein the processing circuitry 120 is further configured to cause distribution of energy E based on an acceleration indicator 11 obtained from the vehicle 10 and to prevent distribution of energy E to the propulsion shaft 14 of the vehicle 10 responsive to the acceleration indicator 11 indicating negative acceleration of the vehicle 10; the internal energy storage device 130 is a super capacitor; the processing circuitry 120 is further configured to cause distribution of energy E of the internal energy storage device 130 to the non-propulsion battery 17 and to prevent distribution of energy E of the internal energy storage device 130 to the propulsion shaft 14 of the vehicle 10 responsive to the energy level E₁₇ of the non-propulsion battery 17 being below a first threshold T₁, and to cause distribution of energy E of the internal energy storage device 130 to the propulsion shaft 14 of the vehicle 10 responsive to the energy level E₁₇ of the non-propulsion battery 17 being above the first threshold T₁; the processing circuitry 120 is further configured to cause distribution of energy E of the internal energy storage device 130 to the propulsion shaft 14 of the vehicle 10 and to prevent distribution of energy E of the internal energy storage device 130 to the non-propulsion battery 17 of the vehicle 10 responsive to the energy level E₁₇ of the non-propulsion battery 17 being above a second threshold T₂, wherein the second threshold T₂ indicating a higher energy level E₁₇ than the first threshold T₁, and to cause distribution of energy E of the internal energy storage device 130 to the non-propulsion battery 17 and to the propulsion shaft 14 of the vehicle 10 responsive to the energy level E₁₇ of the non-propulsion battery 17 being between the first and second thresholds T₁, T₂; the processing circuitry 120 is further configured to provide a recuperation indication to the vehicle 10 indicating that the vehicle 10 is to operate at an enforced energy recuperation mode, and to provide the recuperation indication to the vehicle 10 responsive to the energy level E₁₇ of the non-propulsion battery 17 being below a minimum threshold Tₘᵢₙ, wherein the minimum threshold Tₘᵢₙ is below the first threshold T₁; the energy recovery system 100 further comprising at least two non-propulsion battery 17, wherein a first non-propulsion battery 17 is configured for providing power to vehicle propulsion control and a second non-propulsion battery 17 is configured for providing power to vehicle comfort control, at least one non-propulsion battery 17 is a battery configured with a nominal voltage below 30 V; the KERS 110 comprises an electrical motor 112 and a flywheel arrangement 114.

Example 17. A vehicle 10 comprising a non-propulsion battery 17 for providing power to the vehicle 10, a propulsion shaft 14, a propulsion motor 12 coupled to the propulsion shaft 14, and an energy recovery system 100 of any one of the preceding examples connected to the propulsion shaft 14.

Example 18. The vehicle 10 of example 17, wherein a controllable disconnect 13 is provided between the propulsion motor 12 and the propulsion shaft 14, wherein the KERS 110 is connected to the propulsion shaft 14 downstream from the propulsion motor and the controllable disconnect 13.

Example 19. The vehicle 10 of example 18, further comprising a vehicle processing circuitry 120 configured to cause the controllable disconnect 13 to disconnect the propulsion motor 12 from the propulsion shaft 14 responsive to obtaining a recuperation indication indicating that the vehicle 10 is to operate at an enforced energy recuperation mode.

Example 20. The vehicle 10 of any one of examples 17 to 19, wherein the vehicle is a heavy-duty vehicles, such as a truck, a bus, or a construction equipment.

Example 21. A method 200 of distributing energy of an internal energy storage device 130 of an energy recovery system 100 according to any one of examples 1 to 16 when comprised in a vehicle 10, the method 200 comprising: obtaining 210 an energy level E₁₇ of a non-propulsion battery 17 connected to the energy recovery system 100, and distributing 230 energy E from the internal energy storage device 130 to a propulsion shaft 14 of the vehicle 10 and/or to the non-propulsion battery 17 based on the energy level E₁₇ of the non-propulsion battery 17.

Example 22. The method of example 21, further comprising: obtaining 220 an acceleration indicator a from the vehicle 10, wherein the distribution of energy E from the internal energy storage device 130 is further based on an acceleration indicator a obtained from the vehicle 10.

Example 23. The method 200 of example 22, further comprising: preventing 235 distribution of energy E from the internal energy storage device 130 to the propulsion shaft 14 of the vehicle 10 responsive to the acceleration indicator a indicating a negative acceleration of the vehicle 10.

Example 24. The method 200 of any one of examples 21 to 23, wherein distributing 230 energy E from the internal energy storage device 130 comprises distributing 231, 232 energy E from the internal energy storage device 130 to the non-propulsion battery 17 and to prevent distribution of energy E from the internal energy storage device 130 to the propulsion shaft 14 of the vehicle 10 responsive to the energy level E₁₇ of the non-propulsion battery 17 being below a first threshold T₁.

Example 25. The method of example 24, wherein distributing 230 energy E from the internal energy storage device 130 further comprises distributing 233, 234 energy E from the internal energy storage device 130 to the propulsion shaft 14 of the vehicle 10 responsive to the energy level E₁₇ of the non-propulsion battery 17 being above the first threshold T₁.

Example 26. The method 200 of example 24 or 25, further comprising, responsive to the energy level E₁₇ of the non-propulsion battery 17 being above a second threshold T₂ indicating a higher energy level E₁₇ than the first threshold T₁: distributing 230 energy E from the internal energy storage device 130 to the propulsion shaft 14 of the vehicle 10, and preventing 235 distribution of energy E from the internal energy storage device 130 to the propulsion shaft 14 of the vehicle 10.

Example 27. The method 200 of example 25 or 26, wherein distributing 230 energy E from the internal energy storage device 130 further comprises distributing 233a energy E from the internal energy storage device 130 to the non-propulsion battery 17 and to the propulsion shaft 14 of the vehicle 10 responsive to the energy level E₁₇ of the non-propulsion battery 17 being between the first and second thresholds T₁, T₂.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, actions, steps, operations, elements, and/or components, but do not preclude the presence or addition of one or more other features, integers, actions, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the disclosure being set forth in the following claims.

1. An energy recovery system for a vehicle, the energy recovery system comprises a Kinetic Energy Recovery System (“KERS”) for connecting to a propulsion shaft of the vehicle, an internal energy storage device configured to receive and store energy from the KERS, and a processing circuitry configured to cause distribution of energy from the internal energy storage device to the propulsion shaft of the vehicle and/or at least one non-propulsion battery for the vehicle based on an energy level of the non-propulsion battery.

2. The energy recovery system of claim 1, wherein the processing circuitry is further configured to cause distribution of energy from the internal energy storage device based on an acceleration indicator obtained from the vehicle.

3. The energy recovery system of claim 2, wherein the processing circuitry is configured to prevent distribution of energy from the internal energy storage device to the propulsion shaft of the vehicle responsive to the acceleration indicator indicating a negative acceleration of the vehicle.

4. The energy recovery system of claim 1, wherein the internal energy storage device is a super capacitor.

5. The energy recovery system of claim 1, wherein the processing circuitry is further configured to cause distribution of energy from the internal energy storage device to the non-propulsion battery and to prevent distribution of energy from the internal energy storage device to the propulsion shaft of the vehicle responsive to the energy level of the non-propulsion battery being below a first threshold.

6. The energy recovery system of claim 5, wherein the processing circuitry is further configured to cause distribution of energy from the internal energy storage device to the propulsion shaft of the vehicle responsive to the energy level of the non-propulsion battery being above the first threshold.

7. The energy recovery system of claim 6, wherein the processing circuitry is further configured to cause distribution of energy from the internal energy storage device to the propulsion shaft of the vehicle and to prevent distribution of energy from the internal energy storage device to the non-propulsion battery responsive to the energy level of the non-propulsion battery being above a second threshold, wherein the second threshold is indicating a higher energy level than the first threshold.

8. The energy recovery system of claim 7, wherein the processing circuitry is further configured to cause distribution of energy from the internal energy storage device to the non-propulsion battery and to the propulsion shaft of the vehicle responsive to the energy level of the non-propulsion battery being between the first and second thresholds.

9. The energy recovery system of claim 1, wherein the processing circuitry is further configured to provide a recuperation indication to the vehicle indicating that the vehicle is to operate at an enforced energy recuperation mode.

10. The energy recovery system of claim 5, wherein the processing circuitry is configured to provide the recuperation indication to the vehicle responsive to the energy level of the non-propulsion battery being below a minimum threshold, wherein the minimum threshold is below the first threshold.

11. The energy recovery system of claim 1, further comprising the at least one non-propulsion battery.

12. The energy recovery system of claim 11, further comprising at least two non-propulsion batteries, wherein a first non-propulsion battery is configured for providing power to vehicle propulsion support functions and a second non-propulsion battery is configured for providing power to vehicle comfort control; the least one non-propulsion battery is a battery configured with a nominal voltage below 30 V.

13. The energy recovery system of claim 1, wherein the KERS comprises an electrical motor.

14. The energy recovery system of claim 13, wherein the KERS further comprises a flywheel arrangement.

15. The energy recovery system of claim 1, wherein the processing circuitry is further configured to cause distribution of energy based on an acceleration indicator obtained from the vehicle and to prevent distribution of energy to the propulsion shaft of the vehicle responsive to the acceleration indicator indicating negative acceleration of the vehicle; the internal energy storage device is a super capacitor; the processing circuitry is further configured to cause distribution of energy of the internal energy storage device to the non-propulsion battery and to prevent distribution of energy of the internal energy storage device to the propulsion shaft of the vehicle responsive to the energy level of the non-propulsion battery being below a first threshold, and to cause distribution of energy of the internal energy storage device to the propulsion shaft of the vehicle responsive to the energy level of the non-propulsion battery being above the first threshold; the processing circuitry is further configured to cause distribution of energy of the internal energy storage device to the propulsion shaft of the vehicle and to prevent distribution of energy of the internal energy storage device to the non-propulsion battery of the vehicle responsive to the energy level of the non-propulsion battery being above a second threshold, wherein the second threshold indicating a higher energy level than the first threshold, and to cause distribution of energy of the internal energy storage device to the non-propulsion battery and to the propulsion shaft of the vehicle responsive to the energy level of the non-propulsion battery being between the first and second thresholds; the processing circuitry is further configured to provide a recuperation indication to the vehicle indicating that the vehicle is to operate at an enforced energy recuperation mode, and to provide the recuperation indication to the vehicle responsive to the energy level of the non-propulsion battery being below a minimum threshold, wherein the minimum threshold is below the first threshold; the energy recovery system further comprising at least two non-propulsion battery, wherein a first non-propulsion battery is configured for providing power to vehicle propulsion control and a second non-propulsion battery is configured for providing power to vehicle comfort control, at least one non-propulsion battery is a battery configured with a nominal voltage below 30 V; the KERS comprises an electrical motor and a flywheel arrangement.

16. A vehicle comprising a non-propulsion battery for providing power to the vehicle, a propulsion shaft, a propulsion source coupled to the propulsion shaft, and an energy recovery system of claim 1 connected to the propulsion shaft.

17. The vehicle of claim 16, wherein the propulsion source is selectively connected to the propulsion shaft by a controllable disconnect, the KERS is connected to the propulsion shaft downstream from the propulsion source and the controllable disconnect; preferably, the vehicle further comprises a vehicle processing circuitry configured to cause the controllable disconnect to disconnect the propulsion source from the propulsion shaft responsive to obtaining a recuperation indication indicating that the vehicle is to operate at an enforced energy recuperation mode.

18. A method of distributing energy of an internal energy storage device of an energy recovery system according to claim 1 when comprised in a vehicle, the method comprising:
obtaining an energy level of a non-propulsion battery connected to the energy recovery system, and
distributing energy from the internal energy storage device to a propulsion shaft of the vehicle and/or to the non-propulsion battery based on the energy level of the non-propulsion battery.

19. The method of claim 18, wherein distributing energy from the internal energy storage device comprises distributing energy from the internal energy storage device to the non-propulsion battery and to prevent distribution of energy from the internal energy storage device to the propulsion shaft of the vehicle responsive to the energy level of the non-propulsion battery being below a first threshold; preferably, distributing energy from the internal energy storage device further comprises distributing energy from the internal energy storage device to the propulsion shaft of the vehicle responsive to the energy level of the non-propulsion battery being above the first threshold.

20. The method of claim 19, further comprising, responsive to the energy level of the non-propulsion battery being above a second threshold indicating a higher energy level than the first threshold:
distributing energy from the internal energy storage device to the propulsion shaft of the vehicle, and
preventing distribution of energy from the internal energy storage device to the propulsion shaft of the vehicle;
preferably, distributing energy from the internal energy storage device further comprises distributing energy from the internal energy storage device to the non-propulsion battery and to the propulsion shaft of the vehicle responsive to the energy level of the non-propulsion battery being between the first and second thresholds.
